(19) United States
(12) Patent Application Publication
(10) Pub. No.: US 2018/0059002 A1
(43) Pub. Date: Mar. 1, 2018

(54) METHOD OF DETERMINATION OF FRICTION COEFFICIENT BETWEEN WHEEL AND SURFACE AND ITS IMPLEMENTATION DEVICE

(71) Applicant: Obschestvo s ogranichennoi otvetstvennostyu "Opytno-konstruktorskoe predpriyatie "VEKTOR", Saint-Petersburg (RU)

(72) Inventors: Alexei Viktorovich Vlasichev, Saint-Petersburg (RU); Sergei Vitalievich Zakharenko, Saint-Petersburg (RU); Anatoly Vasilievich Nizovoi, Saint-Petersburg (RU); Leonty Leontievich Filichev, Saint-Petersburg (RU)

(73) Assignee: Obschestvo s ogranichennoi otvetstvennostyu "Opytno-konstruktorskoe predpriyatie "VEKTOR", Saint-Petersburg (RU)

(21) Appl. No.: 15/680,455

(22) Filed: Aug. 18, 2017

(30) Foreign Application Priority Data
Aug. 23, 2016 (RU) RU2016134470

(51) Int. Cl. G01N 19/02

(52) U.S. Cl. CPC G01N 19/02; B60T 8/171

(57) ABSTRACT

Invention lies in the field of measuring equipment for determination of frictional parameters of surfaces of aerodrome runways or road pavements.

The method includes rolling motion of a measuring wheel by a vehicle on a monitored surface, determination of its motion speed, force of its normal load on a surface and its angular rotational velocity, application of braking moment to the axle of a wheel by means of electromagnetic induction brake, rotor of which is connected to the axle of the wheel, determination of a sliding coefficient of the wheel, change of braking moment to make current value the sliding coefficient closer to the assigned value, determination of force of traction between the wheel and the surface using an analog sensor of magnetic flux density mounted on the stator of electromagnetic brake between the poles of the latter, and determination of friction coefficient between the wheel and the surface.

The device includes a frame installed on a vehicle, electromagnetic induction brake, stator of which is installed on the frame, a measuring wheel installed on brake rotor shaft, pressure force transducer, angular rate sensor of the wheel, an element of vehicle's speed determination, sensor of force of traction between the wheel and monitored surface made as an analog sensor of magnetic flux density and installed on brake stator between its poles, a computing block and a control unit.

Technical result consists in increase of accuracy of friction coefficient determination, in simplification of design and reduction of dimensions and weight of the device.

### PERTINENT ART

The group of inventions lies within the field of measurement technology and may primarily be used to determine friction parameters during interaction of a vehicle wheel with a surface, particularly, in order to estimate condition of aerodrome runways or road surfaces.

### PRIOR ART

Methods of determination of friction coefficient between a wheel and aerodrome pavement surface are known (RU 2298166 C1, 2007; RU 2390003 C9, 2010). The listed methods include the following in their common part:
rolling motion of a measuring wheel on a monitored surface;
application of braking torque to the axle of a measuring wheel with engagement of a DC generator with active load and a shaft connected to the axle of the measuring wheel;
determination of start of measuring wheel sliding on the basis of comparison of signals from two angular rate sensors, one of which is mounted on the measuring wheel and the other—on the driven wheel;
maintaining condition of start of measuring wheel sliding on the basis of comparison of signals from angular rate sensors through change of braking torque value by means of alteration of active generator load;
change of traction of the measuring wheel and the surface due to the friction of the wheel on the surface by means of strain sensor;
determination of friction coefficient between the measuring wheel and the surface as the ratio between traction of the measuring wheel and the surface and the known force of normal load of the measuring wheel on the surface.

Method of determination of friction coefficient between a wheel and aerodrome pavement surface is known (RU 2393460 C1, 2010). The mentioned method includes:
rolling motion of a measuring wheel on a monitored surface;
application of braking force moment to the axle of a measuring wheel with engagement of a DC generator with active load and a shaft connected to the axle of the measuring wheel;
measurement of braking force moment created with a DC generator by means of first torque strain sensor mounted between the shaft of DC generator rotor and measuring wheel axle;
measurement of wheel and surface traction force moment created by the wheel friction on the surface by means of the second torque strain sensor mounted on the disk of the measuring wheel;
determination of beginning of measuring wheel sliding on the basis of comparison of signals of first and second torque strain sensors at the moment of their equality;
maintaining condition of start of measuring wheel sliding on the basis of comparison of signals from first and second torque strain sensors through change of braking force moment value by means of alteration of active generator load;
determination of friction coefficient between the measuring wheel and the surface as the ratio between moment of tractive force of the measuring wheel and the surface and the product of radius of the measuring wheel by the known force of normal load of the measuring wheel on the surface.

Method of determination of friction coefficient between a wheel and paved surface is known (RU 2442136 C1, 2012). The mentioned method includes:
rolling motion of a measuring wheel on a monitored surface;
application of braking force moment to the axle of a measuring wheel with engagement of an electromagnetic powder brake, rotor of which is connected to the axle of the measuring wheel;
measurement of braking force moment created with an electromagnetic brake by means of first torque strain sensor mounted between the electromagnetic brake rotor and measuring wheel axle;
measurement of wheel and surface traction force moment created by the wheel friction on the surface by means of the second torque strain sensor mounted on the disk of the measuring wheel;
determination of beginning of measuring wheel sliding on the basis of comparison of signals of first and second torque strain sensors at the moment of their equality;
maintaining condition of beginning of measuring wheel sliding on the basis of comparison of signals from first and second torque strain sensors by changing braking force moment value by means of alteration of current through electromagnetic brake winding;
determination of friction coefficient between the measuring wheel and the surface as the ratio between moment of tractive force of the measuring wheel and the surface and the product of radius of the measuring wheel by the known force of normal load of the measuring wheel on the surface.

The drawback of all the known methods above is that during their realization determination of friction coefficient between wheel and surface is carries out in the state of the beginning of measuring wheel sliding, when value of sliding coefficient K_{SL} is close to zero, and this coefficient, as is well known, is determined through the expression K_{SL}=(1−ω_{MW}R_{MW}/V_{MW}), where ω_{MW}—angular velocity of a measuring wheel; R_{MW}—radius of a measuring wheel; V_{MW}—velocity of measuring wheel motion.

In addition, it is known that maximum value of friction coefficient between a landing gear wheel and surface, which is to be determined as per the requirements of International Civil Aviation Organization (ICAO) during monitoring of surfaces of aerodrome pavements, is ensured at different values of the sliding coefficient that depend on current condition of aerodrome pavement. Thus, for instance, a maximum value of friction coefficient between wheel and dry surface, wet surface and ice-covered surface is reached at the values of sliding coefficient equal to 0.18-0.20; 0.13-0.17 and 0.07-0.12 accordingly. Due to the above, ICAO requires to carry out monitoring of aerodrome pavings' surfaces in order to determine maximum value of friction coefficient between landing gear wheel and surface at the values of sliding coefficient, which correspond to a current state of a runway.

That is why all the above-mentioned known alternatives of the stated method do not provide possibility of determination of the very maximum value of friction coefficient between wheel and surface at the values of sliding coefficient, which correspond to a current state of a runway and it leads to deterioration of accuracy of friction coefficient determination.

Besides, during implementation of all the above-mentioned known alternatives of the stated method use of known value of force of normal load of measuring wheel on surface to calculate friction coefficient between wheel and surface, which is obtained beforehand in the course of bench tests and therefore may differ from the current value in direct surface monitoring, leads to occurrence of error of determination of sliding coefficient, which also deteriorates accuracy of its determination.

The closest to the stated method of determination of friction coefficient between wheel and surface in the aspect of technical essence is the known method, which is implemented in known device of electromechanical measurement of friction coefficient between wheel and aerodrome pavement surface (RU 2434093 C1, 2011). The mentioned known method includes:
rolling motion of a measuring wheel on a monitored surface;
measurement of force of normal load of measuring wheel on the surface with a strain sensor;
application of braking force moment to the axle of a measuring wheel with engagement of a DC generator with active load and a shaft connected to the axle of the measuring wheel;
measurement of angular rotational velocity of measuring wheel with an angular rate sensor;
determination of motion speed of measuring wheel by means of global satellite navigational system receiver;
determination of current value of sliding coefficient on the basis of obtained values of measuring wheel angular rotational velocity and its motion speed taking into account the known radius of the measuring wheel;
comparison of obtained value of sliding coefficient and the assigned value;
change of sliding coefficient value in order to make it closer to the assigned value by changing value of braking moment with alteration of active generator load;
change of traction of the measuring wheel and the surface due to the friction of the wheel on the surface by means of strain sensor;
determination of friction coefficient between the measuring wheel and the surface as the ratio of obtained traction of the measuring wheel and the surface to the obtained value of force of normal load of the measuring wheel on the surface.

When applying the mentioned method, which is the closest alternative, use of measurement of force of normal load of measuring wheel on a surface with a strain sensor allows determining current value of this force directly in the process of surface monitoring, which results in reduced error of friction coefficient determination as compared to the above-mentioned alternatives.

Thanks to the use of change of sliding coefficient value in order to make it closer to the assigned value, the method, which is the closest alternative, unlike the above-mentioned alternative methods, ensures possibility of determination of maximum value of friction coefficient between the wheel and the surface at assigned value of sliding coefficient that corresponds to the current state of runway, which results in increased accuracy of its determination.

At the same time, availability of mechanical elements of link between measuring wheel and traction strain sensor and measuring wheel axle with DC generator shaft that creates braking force moment in the device, which allows realization of the known method, not only makes the design of this device more complicated and leads to enlargement of its dimensions and weight, but also causes error of determination of friction coefficient due to existing backlashes and clearances in these mechanical elements, which, at that, depend on their operating conditions and service life.

Besides, insufficiently high sensitivity of strain sensor implemented in the closest alternative and its significant dependence on temperature also lead to deterioration of accuracy of friction coefficient between wheel and surface.

The listed drawbacks are typical for all the above-mentioned known methods with similar purpose.

Devices for implementation of the above-mentioned methods of determination of friction coefficient between wheel and aerodrome pavement surface (RU 2298166 C1, 2007; RU 2390003 C9, 2010), which describe in their common part measuring trailer and recording unit, are known. Measuring trailer is equipped with a measuring wheel, driven wheels, DC generator with a block of power circuit switches and active load, lock-up clutch, reduction gear and freewheel clutch that connect axle of the measuring wheel and generator rotor, two angular rate sensors and strain sensor. Recording unit contains computer, control panel, control unit, memory unit, controller and display.

A device for implementation of the above-mentioned method of determination of friction coefficient between a wheel and aerodrome pavement surface (RU 2393460 C1, 2010), which contains measuring wheel with a torque strain sensor mounted on its disk, reduction gear, DC generator, which is equipped with a voltage regulator and rotor of which is connected to the axle of the measuring wheel through reduction gear and another torque strain sensor, microcontroller, active load unit, pulse-width modulation unit and memory unit, is known.

A device for implementation of the above-mentioned method of determination of friction coefficient between a wheel and paved surface (RU 2442136 C1, 2012), which contains a measuring wheel, two torque strain sensors, electromagnetic powder brake, a microcontroller and power stage, is known.

However, as it was described in detail previously during the description of the known methods, the above-mentioned known alternatives of the stated device do not provide possibility of determination of a maximum value of friction coefficient between wheel and surface at the values of sliding coefficient, which correspond to a current state of a runway and it leads to deterioration of its determination accuracy.

Besides, in the above-mentioned devices of similar purpose, use of known value of force of normal load of measuring wheel on surface to calculate friction coefficient between wheel and surface, which is determined beforehand in the course of bench tests and therefore may differ from the current value in direct surface monitoring, leads to occurrence of error of determination of sliding coefficient, which also deteriorates accuracy of its determination.

The closest to the stated device of determination of friction coefficient between a wheel and surface in the aspect of technical essence is the known device of electromechanical measurement of friction coefficient between wheel and aerodrome pavement surface (RU 2434093 C1, 2011). The mentioned closest analog includes vehicle basis, platform with rotation axis, suspension beam with rotation axis, measuring wheel with measuring wheel hub and shaft, system of raise/lower and assignment of predetermined pressure on the measuring wheel, shock absorber, reduction gear, extension type drive shaft, separately excited generator, pressure strain sensor, angular rate sensor, friction force strain sensor, carriage with its displacement shafts, block of resistors, generator control unit, navigational satellite system receiver, automatic control system and control panel.

In the mentioned device, which is the closest analog, use of strain sensor of pressure for measurement of force of normal load of measuring wheel on a surface allows determining current value of this force directly in the process of surface monitoring, which results in reduced error of friction coefficient determination as compared to the above-mentioned alternatives.

Due to availability of navigational satellite system receiver, angular rate sensor, automatic control system, generator control system and separately excited generator in the mentioned device, which is the closest analog, it is possible to measure friction coefficient of a measuring wheel in order to make it closer to an assigned value, which, unlike the above-mentioned devices with similar purpose, in its turn, ensures possibility of determination of maximum value of friction coefficient between wheel and surface at the assigned value of sliding coefficient that corresponds to the current state of a runway and that results in increase of accuracy of its determination.

At the same time, availability of such mechanical assemblies of link of measuring wheel shaft and DC generator rotor as reduction gear and expandable drive shaft, as well as such mechanical assemblies of link of measuring wheel and strain sensor of force as measuring wheel shaft, hub, hub shaft and carriage that is installed so that it can move along two shafts not only makes the design of this known device more complicated and leads to enlargement of its dimensions and weight, but also results in occurrence of error of friction coefficient determination due to existing backlashes and clearances in these mechanical elements, which also depend on operating conditions and service life.

Besides, insufficiently high sensitivity of strain sensors, which may be implemented in the closest alternative, and its significant dependence on temperature also leads to deterioration of accuracy of friction coefficient between wheel and surface.

The listed drawbacks are typical for all the devices with similar purpose listed above.

### DISCLOSURE OF THE INVENTION

The aim of present group of inventions was to create a method to determine friction coefficient between a wheel and surface and devices for implementation of such method, which ensure reaching a technical result that is to increase accuracy of friction coefficient determination, to make design more simple, to decrease dimensions and weight of a device as well as to expand toolkit of technical aids with similar purpose.

According to the present invention, method of determination of friction coefficient between wheel and surface includes:
rolling motion of a measuring wheel by means of a vehicle on a monitored surface;
determination of measuring wheel motion speed;
measurement of force of normal load of the measuring wheel on the surface;
application of braking force moment to the axle of the measuring wheel with engagement of an electromagnetic induction brake, rotor of which is connected to the axle of the measuring wheel;
measurement of angular rotational velocity of measuring wheel;
determination of current value of sliding coefficient on the basis of obtained values of measuring wheel angular rotational velocity and its motion speed taking into account the known radius of the measuring wheel;
change of braking moment value to make current value of sliding coefficient closer to the assigned value;
determination of force of traction between the measuring wheel and the surface using an analog sensor of flux density that is mounted on the stator of electromagnetic induction brake between its poles;
determination of friction coefficient between the measuring wheel and the surface as the ratio of obtained traction of the measuring wheel and the surface to the obtained value of force of normal load of the measuring wheel on the surface.

At that, determination of motion speed of measuring wheel is carried out by means of global satellite navigational system receiver.

Determination of rotational velocity of the measuring wheel is carried out on the basis of angular rotational velocity of the driven wheel of the vehicle, obtained through angular rate sensor.

Hall effect sensor is used as an analog sensor of flux density.

Determination of force of traction of a measuring wheel and surface is carried out using Hall effect sensor that is mounted on the stator of electromagnetic induction brake between the poles of the latter with the sensitive surface of the sensor in parallel to brake rotor.

Determination of force of traction of a measuring wheel and surface is carried out using Hall effect sensor that is mounted on the stator of electromagnetic induction brake between the poles of the latter, equidistantly.

In the stated method, use of electromagnetic induction brake, rotor of which is connected directly to the axle of the measuring wheel, to create braking force moment doesn't require implementation of mechanical assemblies for link between measuring wheel axle and electromagnetic induction brake rotor, which, compared to all the above-mentioned analogs, firstly, simplifies the design of the device for implementation of the stated method and leads to decrease of its dimensions and weight, and, secondly, ensures reduction of error of friction coefficient, which occurs in the above-mentioned analogs due to existing backlashes and clearances in those mechanical elements of link that also depend on operating conditions and their service life.

In the stated method, use of electromagnetic induction brake, moment of braking force of rotor of which is directly proportional to the square of magnetic flux density, to create the braking force moment provided a possibility to determine force of traction between measuring wheel and surface using analog sensor of flux density, in particular, by means of Hall effect sensor, which is mounted on the stator of electromagnetic induction brake between its poles and output signal of which is directly proportional to the value of magnetic flux density.

At that, use of Hall effect sensor, which has significantly lesser dimensions and weight as compared to strain sensors of the above-mentioned alternatives, to determine force of traction between measuring wheel and surface doesn't require implementation of mechanical assemblies for link between measuring wheel and a strain sensor, which, compared to the above-mentioned analogs, firstly, simplifies the design of the device for implementation of the stated method and leads to decrease of its dimensions and weight, and, secondly, ensures reduction of error of friction coefficient, which occurs in the above-mentioned analogs due to existing backlashes and clearances in those mechanical elements of link that also depend on operating conditions and their service life.

Besides, Hall effect sensors are characterized by high sensitivity, quite stable in the conditions of varying temperature, which also contributes into increase of accuracy of determination of friction coefficient between a wheel and a surface.

According to this invention, device for determination of friction coefficient between wheel and surface includes

a frame installed on a vehicle,

measuring wheel,

assembly to create braking force moment mounted on the frame, made as an electromagnetic induction brake with a stator installed on the frame and measuring wheel installed on the rotor shaft,

pressure force transducer installed to provide possibility of measurement of vertical pressure force exerted by the measuring wheel on the monitored surface,

measuring wheel angular rate sensor, an element for determination of the vehicle speed,

sensor of force of traction between the measuring wheel and the surface as an analog sensor of flux density that is mounted on the stator of electromagnetic induction brake between its poles,

computing block, to the outputs of which outputs of pressure force transducer, measuring wheel angular rate sensor, the element for determination of the vehicle speed, and of traction force sensor are connected,

control unit, input of which is connected to the output of the computing block and the output of which is connected to the assembly that creates braking force moment.

At that, pressure force transducer is made as a strain gage.

Measuring wheel angular rate sensor is made as a digital Hall effect sensor and installed on the frame with a possibility of magnetic interaction with the fins of air cooling impeller of electromagnetic induction brake.

The element for determination of the vehicle speed is made as a satellite navigational system receiver.

The vehicle's speed determination element is made as a digital Hall effect sensor and installed on the frame with a possibility of magnetic interaction with the fins that are made on the disk of vehicle's driven wheel.

Analog sensor of magnetic flux density is made as an analog Hall effect sensor.

The analog Hall effect sensor is installed with its sensitive surface in parallel to the brake rotor.

The analog Hall effect sensor is installed equidistantly from the poles of the brake stator.

Stator of electromagnetic induction brake is installed on the frame on a suspension, which is installed on the frame with possibility of a turn around a horizontal axis by means of measuring wheel lower/raise drive.

Structural design of an assembly for creation of braking force moment as an electromagnetic induction brake, stator of which is mounted on the frame and rotor of which has measuring wheel installed on it, in the stated device doesn't require implementation of mechanical assemblies for link between measuring wheel axle and electromagnetic induction brake rotor, which, compared to all the above-mentioned analogs, firstly, simplifies the design of the stated device and leads to decrease of its dimensions and weight, and, secondly, ensures reduction of error of friction coefficient, which occurs in all the above-mentioned analogs due to existing backlashes and clearances in those mechanical elements of link that also depend on operating conditions and their service life.

Structural design of an assembly for creation of braking force moment as an electromagnetic induction brake, moment of braking force of rotor of which is directly proportional to the square of magnetic flux density, in the stated stated device provided a possibility to make sensor of force of traction between measuring wheel and surface as an analog sensor of flux density, in particular, by means of analog Hall effect sensor, which is mounted on the stator of electromagnetic induction brake between its poles and output signal of which is directly proportional to the value of magnetic flux density.

At that, implementation of analog Hall effect sensor, which has significantly lesser dimensions and weight as compared to strain sensors of all the above-mentioned alternatives, as a sensor for determination of force of traction between measuring wheel and surface doesn't require implementation of mechanical assemblies for link between measuring wheel and such sensor, which, compared to all the above-mentioned analogs, firstly, simplifies the design of the device for implementation of the stated method and leads to decrease of its dimensions and weight, and, secondly, ensures reduction of error of friction coefficient, which occurs in all the above-mentioned analogs due to existing backlashes and clearances in those mechanical elements of link that also depend on operating conditions and their service life.

Besides, Hall effect sensors are characterized by high sensitivity, quite stable in the conditions of varying temperature, which also contributes into increase of accuracy of determination of friction coefficient between a wheel and a surface.

### BRIEF DESCRIPTION OF DRAWINGS

FIG. 1 shows general front and right-side view of the mechanical assemblies of the stated device for determination of friction coefficient between wheel and surface that allows implementing the stated method of determination of traction between wheel and surface, where 1—frame; 2—brake stator; 3—brake rotor; 4—measuring wheel; 5—suspension; 6—suspension axle; 7—impeller fin; 8—actuator arm; 9—shock absorber; 10—threaded shaft; 11—lower/raise motor; 12—pressure force transducer; 13—angular rate sensor; 14—traction force sensor; 15—stator pole and 16—rotor shaft.

FIG. 2 shows general front and left-side view of the mechanical assemblies of the stated device for determination of friction coefficient between wheel and surface that allows implementing the stated method of determination of friction coefficient between wheel and surface, at which measuring wheel is not shown and where 17 is arm pivot shaft.

FIG. 3 shows structural diagram of electrical and electronic assemblies of the stated device for determination of friction coefficient between wheel and surface that allows implementing the stated method of determination of friction coefficient between wheel and surface, where 18—computing block; 19—element of vehicle's speed determination and 20—control unit.

### PREFERRED EMBODIMENT OF THE INVENTION

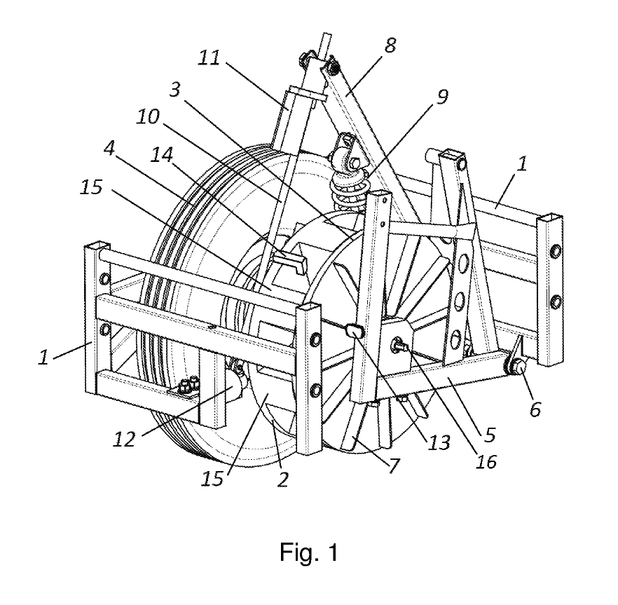

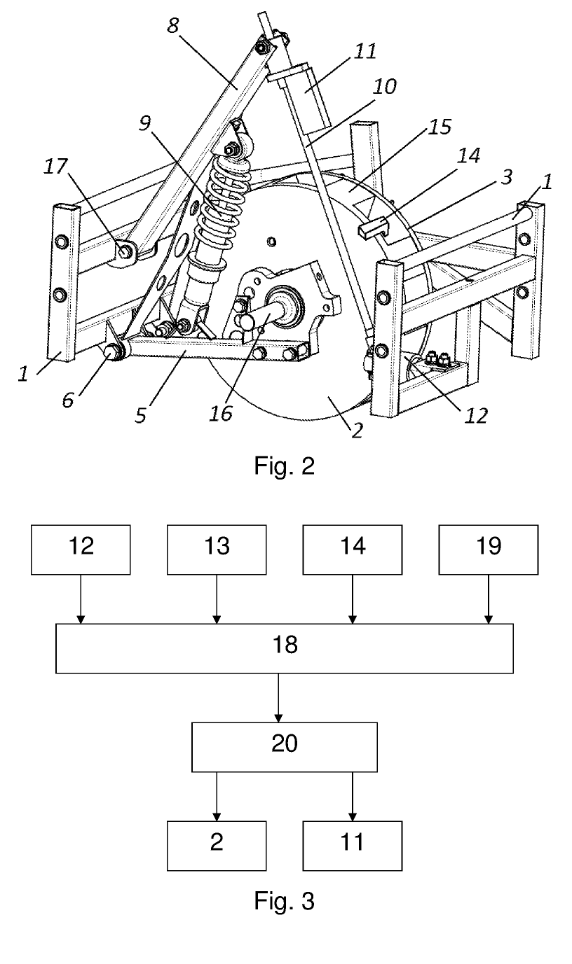

The device for determination of friction coefficient between wheel and surface that allows implementing the stated method of determination of friction coefficient between wheel and surface contains (See FIGS. 1 and 2) metal frame 1 installed on a vehicle and assembly for creation of braking force moment made as an electromagnetic induction brake, which includes brake stator 2 and brake rotor 3. Brake stator 2 is mounted on the frame 1 by means of suspension 5 made as an arm and installed on the frame 1 with possibility to turn around horizontal pivot shaft 6 of the suspension. Brake stator 2 contains concentrically placed solenoids with cores, outer faces of which make stator poles 15. Brake rotor 3 is made as a disk from conductive material and mounted coaxially on brake stator 2 by means of rotor shaft 16 with possibility of rotation in a bearing. On the outer surface of brake rotor 3 air cooling impeller made as radial impeller fins 7 from magnetically conductive material is installed.

The device also includes measuring wheel 4, which is installed on rotor shaft 16 on the side opposite to brake stator 2 and therefore can rotate along with brake rotor 3 respective to brake stator 2.

The device is equipped with a measuring wheel lower/raise drive 4 that includes actuator arm 8 installed on the frame 1 with possibility of rotation around horizontal arm pivot shaft 17 and interacting with suspension 5 through shock absorber 9 to ensure creation of assigned vertical pressure force of measuring wheel 4 on the monitored surface. Lower/raise drive of measuring wheel 4 also includes threaded shaft 10, one end of which is connected through a hinge to pressure force strain sensor 12 mounted on the frame 1. Model 355 type sensor by Vishlay, Tedea-Huntleigh, is used as pressure force transducer 12, for example. The other end of threaded shaft 10 goes through hollow bushing installed by means of a hinge at the end of arm 8; lower/raise electrical motor 11 is mounted on this bushing. A nut that interacts with lower/raise motor 11 rotor to ensure possibility of its rotation is screwed on the threaded shaft 10. A single-frame design of MGH 100/50 type actuator by TEA Technische Antriebselemente, GmbH, is used, for example, to make lower/raise motor 11, threaded shaft 10 and the mentioned nut.

The device is equipped with measuring wheel angular rate sensor 13, which is made as a digital Hall effect sensor and installed on the frame 1 with a possibility of magnetic interaction with the fins 7 of air cooling impeller of electromagnetic induction brake. A digital Hall effect sensor of SS41 type by Honeywell is used, for example, as an angular rate sensor 13.

The device is equipped with a sensor 14 of traction between the measuring wheel 4 and monitored surface, which is made as an analog magnetic flux density sensor, specifically, as an analog Hall effect sensor, and installed on the stator of electromagnetic induction brake between its neighboring poles. In the optimal implementation of the invention sensor 14 of traction is installed equidistantly from the neighboring poles 15 of stator with its sensitive surface in parallel to brake rotor 3. An analog Hall effect sensor of SS49 type by Honeywell is used, for example, as an angular rate sensor 14.

The device is equipped with (See FIG. 3) an element of vehicle speed measuring 19 (not shown in FIGS. 1 and 2), which is made either as a satellite navigational system (GPS) receiver or a digital Hall effect sensor, similar to the one used as an angular rate sensor 13 of measuring wheel 4 and installed with a possibility of magnetic interaction with the fins made on the disk of the vehicle's driven wheel. The device includes computing block 18, which is made on the basis of a microprocessor, for example, CPC10703 type by Fastwel, and has internal analog-to-digital converters, digital-to-analog converters, I/O interfaces, ROM and RAM. Inputs of computing block 18 are connected to outputs of vehicle's speed measuring element 19, traction force sensor 14, angular rate sensor 13 and pressure force transducer 12.

The device is equipped with a control unit 20, which is made on the basis of LM1085 electronic linear regulators by Texas Instruments and IRF530 type power transistors by International Rectifiers company. Input of control unit 20 is connected to the output of computing block 18 and two outputs are connected to the windings of brake stator 2 solenoids and to lower/raise drive 11 accordingly.

The device for determination of friction coefficient between wheel and surface that allows implementing the stated method of determination of friction coefficient between wheel and surface operates as follows.

A vehicle, on which the device for determination of friction coefficient between a wheel and a surface, is moving along the monitored surface of aerodrome or road pavement.

By the signal from the computing block 18 control unit 20 engages lower/raise motor 11, which rotates the nut that is screwed on the threaded shaft 10 and thus moves it downward (See FIGS. 1 and 2). As a result of this, actuator arm 8 turns on arm pivot shaft 17 and through shock absorber 9 acts on suspension 5, which also turns on suspension pivot shaft 6, thus providing lowering of brake stator 2 with brake rotor 3 and measuring wheel 4 down to measuring wheel 4 touchdown of the monitored surface. At that, pressure force transducer 12 generates analog electrical signal, which is proportional to force of action of the frame 1 via threaded shaft 10, actuator arm 8, shock absorber 9 and suspension 5 on the measuring wheel 4 and, consequently, to the force of pressure of measuring wheel 4 on the monitored surface. The mentioned electrical signal from pressure force transducer 12 goes into the computing block 18, where it is compared to the assigned value after its conversion into a digital code. In case of equality of the digital code and its assigned value the computing block 18 turns off lower/raise drive 11 through control unit 20, as force of pressure of the measuring wheel 4 on the monitored surface has reached the assigned value.

Friction of the measuring wheel 4 on the monitored surface starts its rotation along with brake rotor 3 on rotor shaft 16.

During synchronous rotation of the measuring wheel 4 and brake rotor 3 angular rate sensor 13 generates electrical pulses as a result of magnetic interaction with each fin 7 of air cooling impeller subsequently, those pulses go to the computing block 18, which converts time intervals between the electrical pulses into digital codes and calculates their average value T per one brake rotor 3 turn.

At the same time a signal that corresponds to the motion speed of the vehicle and, therefore, motion speed of measuring wheel 4, from the element 19 of vehicle's motion speed determination goes into computing block 18, which converts it into digital code. Computing block 18 calculates current value of sliding coefficient K_{SL} based on formula K_{SL}=1−2πR_{MW}/(NTV_{MW}), where R_{MW}—known radius of measuring wheel 4, which has been determined before during device calibration in the process of measuring wheel 4 motion without sliding; N—number of air cooling impeller fins 7; T—average value of time intervals between the electrical pulses; V_{MW}—motion speed of measuring wheel 4.

After that computing block 18 compares the obtained value of sliding coefficient K_{SL} with the assigned value, at which maximum value of friction coefficient between wheel and surface is ensured in the current conditions of the latter.

While electromagnetic induction brake does not create braking force moment measuring wheel 4 moves over the monitored surface without sliding and current value of sliding coefficient K_{SL} is equal to zero. That is why during comparison current value of sliding coefficient K_{SL} would be less than the assigned value. In this case, by the signal from computing block 18 control unit 20 switches voltage to windings of brake stator 3 solenoids and electric current starts flowing through them. The current through brake stator 3 solenoids' windings creates a magnetic field, which induces Foucault currents in brake rotor 3 that rotates in this magnetic field; the Foucault currents create magnetic field that counteracts brake rotor 3 rotation and, hence, measuring wheel 4 rotation. As a result of this, measuring wheel 4 starts sliding on the monitored surface.

By the signals generated by computing block 18 on the basis of constant comparison of a current value of sliding coefficient K_{SL} and the assigned value control unit 20 increases voltage on windings of brake stator 2 solenoids that leads to increase of measuring wheel 4 braking force moment until the current value of sliding coefficient K_{SL} is equal to its assigned value. Then, by the signals generated by computing block 18 on the basis of comparison of a current value of sliding coefficient K_{SL} and the assigned value control unit 20 constantly changes voltage supply on windings of brake stator 2 solenoids thus providing creation of measuring wheel 4 braking force moment, at which the current value of sliding coefficient K_{SL} is close to its assigned value.

After that an analog electrical signal that is proportional to the flux density of the magnetic field created by brake stator 2 and is coming from traction force sensor 14 into the computing block 18 is converted into a digital code, being the last. Whereas moment of braking force created by the electromagnetic brake is proportional to the square of magnetic flux density, at the stage of bench calibration of the device calibration curve of dependence between the values of electrical signal generated by traction force sensor 14 and traction force between the measuring wheel 4 and surface was obtained and entered into computing block 18 ROM. Using that dependence, the computing block 18 determines current value of force of traction between measuring wheel 4 and the monitored surface on the basis of value of electrical signal from traction force sensor 14. After that, the computing block 18 determines current value of friction coefficient between the measuring wheel 4 and monitored surface as a ratio between current value of measuring wheel 4 force of traction with the monitored surface and current value of measuring wheel 4 force of pressure on the monitored surface, which is obtained from pressure force transducer 12.

Upon completion of monitoring surface of aerodrome or road pavement, by the signal from the computing block 18 control unit 20 engages lower/raise motor 11, which rotates the nut that is screwed on the threaded shaft 10 in the opposite direction and thus moves it upwards (See FIGS. 1 and 2). As a result of this, actuator arm 8 turns on arm pivot shaft 17 and through shock absorber 9 raises the suspension 5, thus turning it around suspension pivot shaft 6 and providing raise of brake stator 2 with brake rotor 3 and measuring wheel 4.

### INDUSTRIAL APPLICABILITY

The materials above confirm the possibility of implementation of present group of inventions and possibility of a solution for a task at hand to create a method to determine friction coefficient between a wheel and a surface and a device for implementation of such method, which ensure reaching a technical result that is to increase accuracy of friction coefficient determination, to make design more simple, to decrease dimensions and weight of a device as well as to expand toolkit of technical aids with similar purpose.

1. A method of determination of friction coefficient between a wheel and a surface, which includes
rolling motion of a measuring wheel by means of a vehicle on a monitored surface;
determination of measuring wheel motion speed;
measurement of force of normal load of a measuring wheel on a surface;
application of braking force moment to the axle of a measuring wheel by means of an electromagnetic induction brake, rotor of which is connected to the axle of the measuring wheel;
measurement of angular rotational velocity of a measuring wheel;
determination of current value of sliding coefficient on the basis of obtained values of measuring wheel angular rotational velocity and its motion speed taking into account the known radius of the measuring wheel;
change of braking moment value to make current value of sliding coefficient closer to the assigned value;
determination of force of traction between a measuring wheel and a surface using an analog sensor of flux density that is mounted on the stator of electromagnetic induction brake between its poles;
determination of friction coefficient between a measuring wheel and a surface as the ratio of obtained traction of the measuring wheel and the surface to the obtained value of force of normal load of the measuring wheel on the surface.

2. Method as per item 1, with the difference in the determination of motion speed of measuring wheel that is the motion speed determination is carried out by means of global satellite navigational system receiver.

3. Method as per item 1, with the difference in the determination of motion speed of the measuring wheel that is the motion speed determination is carried out on the basis of angular rotational velocity of the driven wheel of the vehicle, obtained through angular rate sensor.

4. Method as per item 1, with the difference in implementation of analog Hall effect sensor as an analog sensor of magnetic flux density.

5. Method as per item 4, with the difference in the determination of force of traction between a measuring wheel and a surface that is the determination is carried out using analog Hall effect sensor mounted on the stator of electromagnetic induction brake between the poles of the stator with the sensitive surface of the sensor in parallel to brake rotor.

6. Method as per item 4, with the difference in the determination of force of traction between a measuring wheel and a surface that is the determination is carried out using analog Hall effect sensor mounted on the stator of electromagnetic induction brake equidistantly between the poles of the stator.

7. A device for determination of friction coefficient between a wheel and a surface, which includes
a frame installed on a vehicle,
measuring wheel,
assembly to create braking force moment mounted on the frame, made as an electromagnetic induction brake with a stator installed on the frame and measuring wheel installed on the rotor shaft,
pressure force transducer installed to provide possibility of measurement of vertical pressure force exerted by the measuring wheel on the monitored surface,
angular rate sensor of a measuring wheel;
element of vehicle's speed determination;
sensor of force of traction between the measuring wheel and the surface as an analog sensor of flux density that is mounted on the stator of electromagnetic induction brake between its poles,
computing block, to the outputs of which outputs of pressure force transducer, measuring wheel angular rate sensor, the element for determination of the vehicle speed, and of traction force sensor are connected,
control unit, input of which is connected to the output of the computing block and the output of which is connected to the assembly that creates braking force moment.

8. Device as per item 7, with the difference in design of a pressure force transducer as a strain gage.

9. Device as per item 7, with the difference in design of a measuring wheel angular rate sensor made as a digital Hall effect sensor and installed on the frame with a possibility of magnetic interaction with the fins of air cooling impeller of electromagnetic induction brake.

10. Device as per item 7, with the difference in design of vehicle's speed determination element made as a satellite navigational system receiver.

11. Device as per item 7, with the difference in design of the vehicle's speed determination element made as a digital Hall effect sensor and installed on the frame with a possibility of magnetic interaction with the fins that are made on the disk of vehicle's driven wheel.

12. Device as per item 7, with the difference in design of an analog sensor of magnetic flux density made an analog Hall effect sensor.

13. Device as per item 12, with the difference in installation of an analog Hall effect sensor with its sensitive surface in parallel to brake rotor.

14. Device as per item 12, with the difference in installation of an analog Hall effect sensor equidistantly from the poles of brake stator.

15. Device as per item 7, with the difference in installation of electromagnetic induction brake stator on the frame on a suspension, which is mounted on the frame with possibility of a turn around a horizontal axis by means of measuring wheel lower/raise drive.
